(19) United States
(12) Patent Application Publication
(10) Pub. No.: US 2018/0117762 A1
(43) Pub. Date: May 3, 2018

(54) DATA EXCHANGE SYSTEM

(71) Applicant: Sphero, Inc., Boulder, CO (US)

(72) Inventors: Corey Earwood, Boulder, CO (US); Brandon Dorris, Erie, CO (US); Bo Adepoju, Boulder, CO (US); Brendon Glanzer, Longmont, CO (US)

(73) Assignee: Sphero, Inc., Boulder, CO (US)

(21) Appl. No.: 15/845,750

(22) Filed: Dec. 18, 2017

Related U.S. Application Data
(63) Continuation-in-part of application No. 14/827,159, filed on Aug. 14, 2015.

(51) Int. Cl. B25J 9/16; B25J 5/00

(52) U.S. Cl. CPC B25J 9/1605; G06F 3/16; B25J 5/00

(57) ABSTRACT

A data exchange system is disclosed herein for receiving motion and attribute data corresponding to user interactions via a robot animation application. The motion and attribute data can be associated with a virtual animation of a virtual character using the robot animation application on a computing device. The data exchange system can translate the motion and attribute data for implementation on a physical or virtual robotic device to perform the virtual animation.

### RELATED APPLICATION

This application is a continuation-in-part of U.S. patent application Ser. No. 14/827,159, filed on Aug. 14, 2015 and titled “Data Exchange System,” which is hereby incorporated by reference in its entirety. To the extent appropriate, priority is claimed to the above application.

### BACKGROUND

Robotic devices are typically programmed to operate through control operations transmitted from a controller device. Furthermore, for pre-programmed implementations, machine manipulation techniques for robotic devices typically involve highly technical, non-mutable data structures.

### SUMMARY

In one aspect, the technology includes a system including: one or more processors; and one or more memory resources storing instructions that, when executed by the one or more processors, cause the system to: receive motion and attribute data corresponding to facial features of a robotic device via a robot animation application, the motion and attribute data associated with a virtual animation of at least a portion of the robotic device; and translate the motion and attribute data for implementation on a robotic device to perform the virtual animation in a real-world environment.

Implementations or examples may also include one or more of the following features. The system where the executed instructions further cause the system to: store data associated with a number of controllable attributes of the robotic device. In another example, translating the motion and attribute data includes utilizing the data associated with the controllable attributes to transform the motion and attribute data into operational controls for execution on the controllable attributes of the robotic device. In yet another example, controllable attributes include features of a display of the robotic device. In still yet another example, controllable attributes further include at least one of a set of audio devices, a set of display or light elements, and a set of motors to drive a drive system of the robotic device. In another example, the facial features include a mouth of the robotic device and at least one eye of the robotic device. In another example, the motion and attribute data corresponds to a number of anthropomorphic facial expressions of the virtual character in the virtual animation, and the executed instructions cause the system to implement the operational controls on the robotic device to invoke the anthropomorphic expressions in the real-world environment. In another example, the executed instructions further cause the system to: store audio clips for lip sync generation, generate phonemes from the stored audio clips, and associate poses of at least a portion of the robotic device with the phonemes. The system may also generate key frames based on the phonemes and the associated poses. In another example, the motion and attribute data includes the key frames. In another example, the executed instructions further cause the system to: receive control inputs for an upper eyelid of the robotic device, generate at least one shape for the upper eyelid based on the control inputs for the upper eyelid, receive control inputs for a lower eyelid of the robotic device, generate at least one shape for the upper eyelid based on the control inputs for the lower eyelid, receive control inputs for an iris of the robotic device, and generate at least one shape for the iris based on the control inputs for the iris. In another example, the at least one shape for the upper eyelid includes a circle, the at least one shape for the lower eyelid includes an oval, and the at least one shape for the iris includes a circle.

Another aspect of the technology includes a computer-implemented method for configuring lip synchronization functionality in a robotic device, the method including: accessing one or more audio clips to be associated with the lip synchronization functionality and generating a plurality of phonemes from the one or more audio clips. The computer-implemented method also includes receiving motion attribute data associated with a virtual character animation, associating the motion attribute data with the plurality of phonemes, adding at least one of the one or more audio clips to an animation timeline, and generating key frames for the animation based on the associated motion attribute data and the audio clips.

Implementations or examples may also include one or more of the following features. The computer implemented method where the motion attribute data includes poses of at least a portion of the robotic device. The computer-implemented method further including: creating a lookup table for at least one of the plurality of phonemes and associating the motion attribute data with the plurality of phonemes further includes saving the associations in the lookup table. The computer-implemented method where generating key frames further includes utilizing the lookup table. The computer-implemented method where generating key frames further includes: generating a temporary audio file for an audio clip in the plurality of audio clips, iterating through detected phonemes in the audio file, identifying a lookup table associated with a detected phoneme for a particular iteration, and calculating a time of the phoneme detection based on at least one of a start time of the audio clip, a start frame that the phoneme is detected within the audio file, or a playback rate setting of an animation application.

Another aspect of the technology includes a computer-implemented method for configuring an eye control feature in a robotic device having an eye display, the method including: receiving a plurality of control inputs for upper eyelids of eyes on the eye display, generating a shape and a command for the upper eyelids based on the upper eyelids control inputs, receiving a plurality of control inputs for lower eyelids of the eyes on the eye display, generating a shape and a command for the lower eyelids based on the lower eyelids control inputs, receiving a plurality of control inputs for irises of the eyes on the eye display and generating a shape and a command for the irises based on the irises control inputs. The computer-implemented method also includes uploading the command for the upper eyelids, the command for the lower eyelids, and the command for the irises to the robotic device.

Implementations or examples may include one or more of the following features. The computer-implemented method where: the shape generated for the upper eyelids is a circle, where the upper eyelids control inputs lie on a circumference of the circle, and the shape generated for the lower eyelids is an oval, where the lower eyelids control inputs lie on a circumference of the oval. The computer-implemented method where the upper eyelids control inputs include at least five control inputs and the lower eyelids control inputs include at least four control inputs. The computer-implemented method where: generating a shape and a command for the lower eyelids based on the lower eyelids control inputs includes calculating an x center location, y center location, a radius, and start and end curve angles on a plurality of upper eyelid controls. The computer-implemented method may also include generating a shape and a command for the lower eyelids based on the lower eyelids control inputs includes calculating an x location, y location, horizontal radius, and vertical radius on a plurality of lower eyelid controls. The computer-implemented method further including generating a three-dimensional representation of: the upper eyelids based on the upper eyelids control inputs; the lower eyelids based on the lower eyelids control inputs; and the irises based on the irises control inputs. The computer-implemented method where the irises control inputs include: a single input for a first iris indicating an x-axis value and a y-axis value for the first iris, and a single input for the second iris indicating an x-axis value and a y-axis value for the second iris.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example data exchange system in connections with operation of a robotic device;

FIG. 2 is a high level flow chart describing an example method of modularizing motion and attribute data into operational commands;

FIG. 3A is a low level flow chart describing an example method for modularizing motion and attribute data into operational commands in an external implementation;

FIG. 3B is a low level flow chart describing an example describing an example method for modularizing motion and attribute data into operational commands in an internal implementation;

FIG. 3C depicts a flow chart of an example method for configuring a lip synchronization feature in a robotic device.

FIG. 3D depicts a flow chart of an example method for configuring an eye control feature in a robotic device having an eye display.

FIG. 4 is schematic diagram illustrating an example robotic device upon which examples described herein may be implemented;

FIG. 5A illustrates an example robotic device utilized in connection with example processes described herein;

FIG. 5B illustrates a similar example robotic device utilized in connection with example processes described herein;

FIG. 6 is a block diagram that illustrates a computer system upon which examples described herein may be implemented.

### DETAILED DESCRIPTION

Systems and methods are provided for exchanging control data between a virtual-based animation system and a real-world robotic system. Thus, a data exchange system is provided to receive motion and attribute data corresponding to user interactions via a robot animation application. The motion and attribute data can be associated with a virtual animation (e.g., an artistic animation of a virtual character) using the robot animation application. The data exchange system can translate the motion and attribute data in accordance with control language of a robotic device. The translated motion and attribute data may then be implemented as operation commands for the robotic device to perform the virtual animation in a real-world environment.

In various implementations, the data exchange system can store data associated with any number of controllable attributes of the robotic device. Along these lines, the data exchange system can further store attributes of multiple robotic systems, and thus correlate robot animation commands for a virtual robot or character of a robot animation application with operational commands that may be implemented on physical robotic system. Accordingly, translation of the motion and attribute data from the robot animation application can comprise utilizing data associated with the controllable attributes of a particular robotic device to transform the motion and attribute data into operational controls for execution on the controllable attributes of the robotic device. Such controllable attributes may comprise a number of actuators that operate movement of a number of aspects of the robotic device, a number of motors that control a drive system that controls velocity and direction of the robotic device, a set of audio devices, a set of light elements, displays, and the like. The robotic device may be any device having any number of controllable attributes, which can range from simplistic systems having few operational parameters (e.g., single motor devices) to complex robotic systems having many attributes (e.g., multiple joints, actuators, drive systems, light and sound components, anthropomorphic features, etc.).

Additionally, an animator tool may be used to create an animation of a particular virtual object or character. As an example, a user (e.g., a human animator) can utilize a robot animation application to animate a virtual character. Using the animator tool, the user can initiate, edit, save, and play-back an animation of a particular virtual character. The user can further utilize timing features and/or trigger-response features of the animator tool to cause the virtual character to perform various movements and/or reactions to certain conditions (e.g., entering a lighted area, seeing a new face, bumping into an object, connecting to a charge port, powering on, sensing a touch input, a certain time of day, receiving a voice or sound command, etc.). Such movements and reactions can include visual, audio, and haptic responses using various motions, light elements, audio elements, displays, etc., and may be tailored to evoke human or animal physical and/or emotional responses. Using the data exchange system provided herein, such expressions can be fine-tuned to include intent, gestures, and/or micro-expressions that may be impossible to achieve with software alone. As used herein, the user's completed animation of the virtual character (e.g., a saved video file, the raw animation data, etc.) is defined as “motion and attribute data” from the robot animation application. Thus, the final animation product of the virtual character and its functions via the robot animation application can be comprised in the motion and attribute data.

In many examples, the data exchange system provided herein receives, as an input, the motion and attribute data associated with the user's animation and configuration of the virtual character. The data exchange system can translate and/or transform the motion and attribute data to implement the animation and configurations on a physical robotic device. The data exchange system can be implemented as an external module to operate the robotic device wirelessly, or the data exchange system may be included as a module of the control system of the robotic device itself. In certain examples, the motion and attribute data may comprise an animation of the virtual character composed of a combination of timed movements, lighting, and sound (e.g., the virtual character performing a scene). Additionally or alternatively, the motion and attribute data can comprise various programmed actions of the virtual character configured as a series of triggered responses to various conditions as provided above.

According to such motion and attribute data, the data exchange system can utilize the controllable attributes of a robotic device, translate/transform the motion and attribute data, and enable and/or program the robotic device to operate in accordance with the configured virtual character. Such operations may include performing scenes, initiating responses to conditions (e.g., motion, lighting, visual, haptic, and/or audio responses), etc. Accordingly, the robotic device may operate as the virtual character in the real-world with a single data exchange module. The motion and attribute data responses of the robotic device may be included in conjunction with ordinary operation of the robotic device. Accordingly, the robotic device can be operated by a user via a controller device, and may instigate configured response functions during operation. Additionally or alternatively, the robotic device may further be operated in a real-world environment as part of a task-oriented activity (e.g., a game having a virtual component on a controller device). Not only may the operate the robotic device to instigate triggered responses, the user may further load a programmed task-oriented activity on the controller device which can cause the robotic device to initiate responses in accordance with the loaded program, and at the same time provide a virtual environment (such as an augmented reality environment) on a generate graphical user interface (GUI) on the controller device. The data exchange system can provide a bridge to enable artists, animators, game developers, etc. to utilize the relatively intuitive animator tools of an animation program in order to ultimately configure the operation of a physical robotic device to enable operative control in the real-world environment in conjunction with correlated task-oriented activities (e.g., gameplay in an augmented reality environment on the GUI).

Among other benefits, examples described herein achieve a technical effect of creating a bridge between the highly intuitive operative controls of an animation application and the typically non-mutable data structures used in the operation of robotic devices, such as remotely operated self-propelled devices.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules or components of a system. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein can be implemented, in whole or in part, on computing devices such as digital cameras, digital camcorders, desktop computers, cellular or smart phones, personal digital assistants (PDAs), laptop computers, printers, digital picture frames, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a non-transitory computer usable carrier medium capable of carrying such a program.

System Description

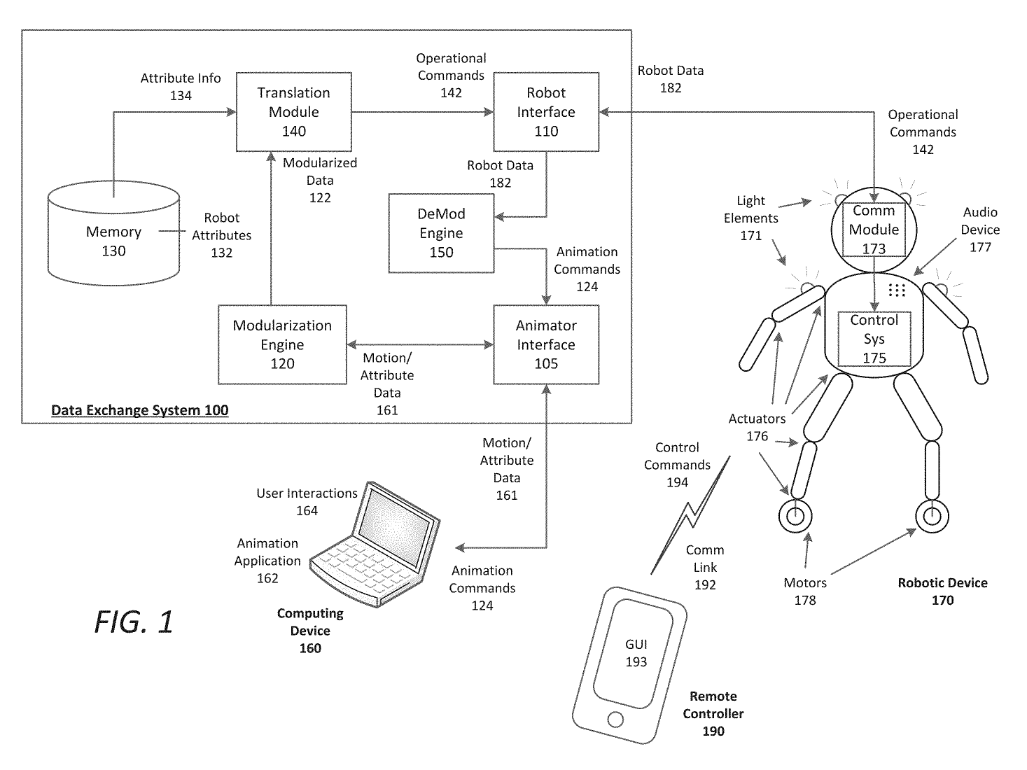

FIG. 1 is a block diagram illustrating an example data exchange system in connections with operation of a robotic device. The data exchange system 100 can include an animator interface 105 to receive motion and attribute data 161 from a computing device 160. The motion and attribute data 161 can comprise data configured by a user of the computing device 160 using an executing animation application 162. Various intuitive controls on the animation application 162 can be utilized to compose a virtual character to perform various functions and responses to certain conditions. The conditions can comprise, without limitation, any touch actions, detected motion, recognition (e.g., facial recognition), changes in light, a certain time of day, certain performed movements (e.g., a spin), detecting a connection (e.g., wireless, power charge), responses to user controls with respect to a task-oriented activity (e.g., gameplay), responses to voice commands or other sound detection, etc. Thus, user interactions 164 with the animation application 162 can result in an animation, or a series of animations, comprising the motion and attribute data 161 for the virtual character on the animation application 162.

The data exchange system 100 described in connection with FIG. 1, can be a portable system that can be connected (wired or wirelessly) to a robotic device 170. Thus, in certain implementations, the data exchange system 100 can be configured as a portable module that can be provided with device attributes of a particular device (e.g., a robotic device having a number of controllable features). The data exchange system 100 can then act as a portable mediator between an animation tool and the controllable device, that enables users to take advantage of highly intuitive animation controls on a computing device 160 in order to cause the controllable device to perform actions comprising movements, timed actions using elements of the controllable device (e.g., lights, sounds, displays, motors or actuators of the device), accelerations, maneuvers, responses to sensor inputs, and the like.

As another example, the portability of the data exchange system 100 can allow for wired connection (e.g., via an interface connector to the device), or incorporation on a control system (e.g., connected chip on a circuit board), on a particular robotic device (e.g., robotic device 170). The data exchange system 100 can be provided with the attributes of the controllable device prior to being connected to the controllable device, or after the system 100 is connected. For some examples, in the latter case, once connected to the controllable device (e.g., robotic device 170), the data exchange system 100 can access resources of the controllable device to identify each of the controllable attributes of the device. In variations of embodiments provided herein, the data exchange system 100 can further provide the computing device 160 with the controllable attributes of the controllable device, so that the animation tool on the computing device 160 can configure a virtual representation of the controllable device to enable a user (e.g., a visual effects artist) to operate the controllable device using the animation tool.

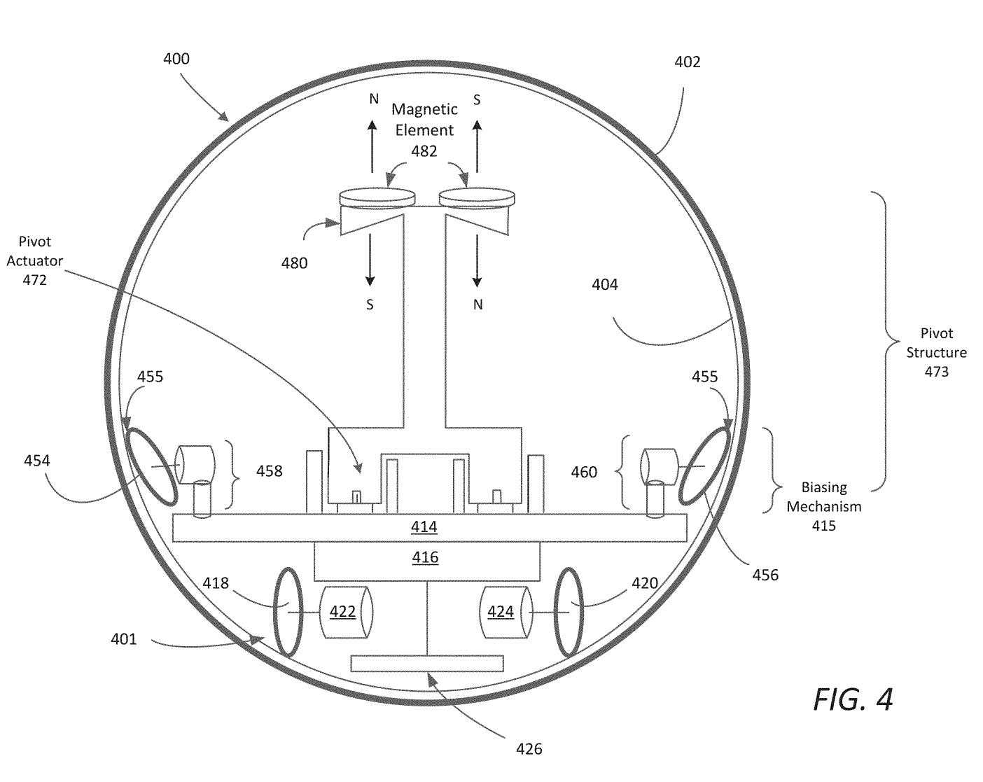

As provided herein, the controllable device is not limited to any specific robotic device (e.g., robotic device 170 or robotic device 400 in FIG. 4). Rather, as a portable module, the data exchange system 100 can apply to any device having any number of controllable attributes.

In addition to the animation(s), the motion and attribute data 161 can further include light data, sound data, video or display data, and/or vibration data, which may be incorporated into the various reactions and responses of the virtual character configured by the user. The animation application 162 can provide the user with a relatively simple tool to create such animations, as well as triggered responses to the conditions discussed above. Each triggered response may be configured as broadly or as narrowly as the user wishes. For example, a broad trigger may comprise a response any time the virtual character bumps into an object. As another example, a narrow trigger may comprise a particular response if the user performs a task, or series of tasks, when operating the robotic device. As yet another example, the trigger may comprise a particular response to voice command or other detected sound. Using the animation application 162, the user can configure the virtual character with any number of animations and triggered responses. The user's configurations of the virtual character can be saved and edited for play-back on the computing device, and, when completed, can be compiled as the motion and attribute data 161 for transmission to the data exchange system 100.

In many examples, the data exchange system 100 receives the motion and attribute data 161 from the computing device 160 and processes the motion and attribute data 161 in a modularization engine 120. The modularization engine 120 can modularize the motion and attribute data 161 from the animation application 162 into usable data 122 for the robotic device 170. In some examples, the motion and attribute data 161 can comprise a video animation of the virtual character. In such examples, the modularization engine 120 may parse the video animation into a sequence of individual actions by individual components of the virtual character (e.g., body part movements, timed sound and/or lighting, accelerations, velocity and direction, human-like or animal-like expressions, etc.). In other examples, the motion and attribute data 161 can be comprised of commands, associated with the user interactions 164, performed on the animation application 162. In these examples, the modularization engine 120 can compile the commands into individual actions performed by each component of the virtual character. Accordingly, the transformed or modularized data 122 can be submitted to a translation module 140 of the data exchange system 100.

In some examples, the data exchange system 100 can include a memory 130 to store robot attributes 132. The data exchange system 100 can store robot attributes 132 for a single robot or multiple robots. Such attributes may include the various physical capabilities and functions of the robotic device 170, such as its motion capabilities, lighting and audio functions, haptic response capabilities, maneuvering and speed capabilities, and the like. In the example provided, the robot attributes 132 in the memory 130 correspond to the robotic device 170, which comprises a number of light elements 171, an audio device 177. a number of actuators 176 that control various joints, and a pair of independent motors 178 that may control velocity and direction of the robotic device 170.

Additionally or alternatively, the translation module 140 can utilize the attribute information 134 of the robotic device 170 in order to format operational commands 142 for the robotic device 170 based on the modularized data 122. The operational commands 142 may be formatted by the translation module 140 as being directly implementable on the control system 175 of the robotic device 175. The data exchange system 100 can include a robot interface 110 to transmit the operational commands 142 to a communication module 173 of the robotic device 170. For example, the translation module 140 can compile the operational commands 142 into a data package for transmission to the robotic device 170.

In certain examples described herein, the communication module 173 of the robotic device 170 can submit the operational commands 142 to the control system 175 for implementation. The operational commands 142 are ultimately dependent upon the user interactions 164 performed by a user (e.g., an artist, animator, game developer, etc.) utilizing the animation application 162 on the computing device 160. Thus, if the user configures the motion and attribute data 161 for a simple performance animation showing a series of motions by a virtual character, the operational commands 142 implemented by the control system 175 on the actuators 176, motors 178, display or light elements 171, and/or audio device 177, can cause the robotic device 170 to initiate a physical performance that mimics the performance animation of the virtual character. The display or light elements 171 may also include a display, such a liquid-crystal-display (LCD) screen. The display may be positioned on a face of the robot to imitate facial features commonly associated with a human or other animals, such as a mouth and eyes. Along these lines, if the user configures the motion and attribute data 161 to include a series of individual triggered responses (which can number into the hundreds to hundreds of thousands of response combinations), the operational commands 142 can operate to program the robotic device 170 to perform each of those series of individual triggered actions in response to the user-configured action on the animation application 162.

In certain implementations, the data exchange system 100 can also operate in the reverse order from that described above. Such variations may enable an animator to configure a template for an animation by operating the robotic device 170, either through physical manipulation or via remote operation user a remote controller 190. A connection may be established between the data exchange system 100 and the robotic device 170, in which the data exchange system 100 can operate in a reverse mode, or a demodularization mode, to receive raw robot data 182 from the robotic device 170, and ultimately output animation commands 124 to the computing device 160. The animation commands 124 can cause the virtual character on the animation application 162 to perform an animation of the physical movements and actions performed by the robotic device 170.

In the above-described variations, the user can operate the robotic device 170 by way of virtual controls generated on the GUI 193 of the remote controller 190 or analog controls using legacy controllers. A communication link 192 may be established between the controller device 190 and the robotic device 170 (e.g., a Bluetooth low energy connection). User interactions with the virtual controls generated on the remote controller 190 can be translated into control commands 194 (e.g., by a control application running on the remote controller 190), which may be transmitted to the robotic device 170 via the communication link 192. Like the operational commands 142, the control commands 194 can be implemented on the various controllable attributes of the robotic device 170 (e.g., the display or light elements 171, the audio device 177, the actuators 176, the motors 178, etc.) by the control system 175 of the robotic device 170 in real-time.

In the demodularization mode, the data exchange system 100 can receive the raw robot data 182, corresponding to various sensors of the robotic device 170 that communicate the raw data from the controllable attributes to the control system 175. In some examples, the sensors may be comprised in an inertial measurement unit (IMU) of the robotic device 170, which can provide not only the raw data corresponding to the controllable attributes, but also various data corresponding to the robotic device's 170 corrections due to dynamic instability, orientation information of the robotic device 170 itself and/or various components of the robotic device 170, and the like. The robot data 182 can be streamed to the data exchange system 100 in real-time, or may be packaged by the control system 175 of the robotic device 170 for subsequent transmission. Thus, the user can physically manipulate the robotic device 170 to perform certain motions and actions, which can be translated in the raw robot data 182.

In some examples, the robot data 182 can be the same as the control commands 194 transmitted from the remote controller 190. In such examples, the communication link 192 may also (or subsequently) be established between the remote controller 190 and the data exchange system 100, and the actual control commands 194 may be communicated directly.

In accordance with various implementations, the data exchange system 100 can include a demodularization engine 150 that can demodularize the robot data 182 and format animation commands 124 based on the data 182. In some examples, the demodularization engine 150 can edit out or otherwise ignore the various minute corrections performed by the robotic device 170 in order to ultimately provide a discreet set of animation commands 124 for the animation application 162. The animation commands 124 generated by the demodularization engine 150 can be directly implemented by the animation application 162 running on the computing device 160 such that the user may store, edit, and play-back a virtual representation of the robotic device's 170 movements and actions. Such examples enable the user to provide a basic framework for using the animation tool of the animation application 162 in order to edit and create more ideal movements and actions for the robotic device 170 in accordance with the user's personal intent—which themselves may be modularized and translated by the data exchange system 100, and the implemented on the robotic device 170 as operational commands 142.

In the above descriptions and examples, the data exchange system can be configured for operation in real-time or near real-time. In these real-time operations, user interactions 164 using the animation application 162 can cause the corresponding motion and attribute data 161 to be streamed to the data exchange system 100 for direct modularization and translation into operational commands 142 for the robotic device 170. Accordingly, the operational commands 142 may also be transmitted to the robotic device 170 in real-time, or near-real time. Thus, a user of the animation tool on the computing device 160 can view the actual robotic device 170 performing actions configured on the visual representation of the robotic device in real-time. Accordingly, the motion and attribute data 161 can be streamed to the data exchange system 100, which modularizes the data and outputs operational commands 142 to be performed by the robotic device 170 in real time. On the other hand, user interactions with the robotic device 170 itself, and/or remote operation of the robotic device 170 via remote controller 190, can cause robot data 182 to be streamed to the data exchange system 100 for demodularization into animation commands 124 in real-time. Accordingly, the data exchange system 100 can output or stream the animation commands 124, corresponding to the direct user operation of the robotic device 170, in real-time. These live animation commands 124 can show a live preview of movements of the robotic device 170 on the visual representation of the robotic device displayed on the computing device 160.

In certain robust implementations, the data exchange system 100 can operate to receive the motion and attribute data 161 as a package for parsing and processing. Thus, the capabilities of the robotic device 170 can be directly associated on a virtual character generated via the animation application 162 on the computing device 160. The user can utilize the animation tool of the animation application 162, editing and playing back various motions, actions, and triggered response actions of the virtual character until a final animation (or series of animations) is accomplished. This final product can be packaged as motion and attribute data 161 by the user (e.g., in a computer file on a flash drive, or for direct wireless transmission to the data exchange system 100). Upon receiving the motion and attribute data 161, the data exchange system 100 can perform the various functions as described herein.

In the various implementations described herein, the animation application 162 need not be a specialized application specific to the data exchange system 100. Rather, numerous and diverse existing animation tools (e.g., off-the-shelf animation software) may be utilized to provide the data exchange system 100 with the motion and attribute data 161. Accordingly, the data exchange system 100 may be compatible with any number of existing animation software that enable a user, such as a graphic artist, to create animations of various objects (e.g., visual representations of controllable devices).

Methodology

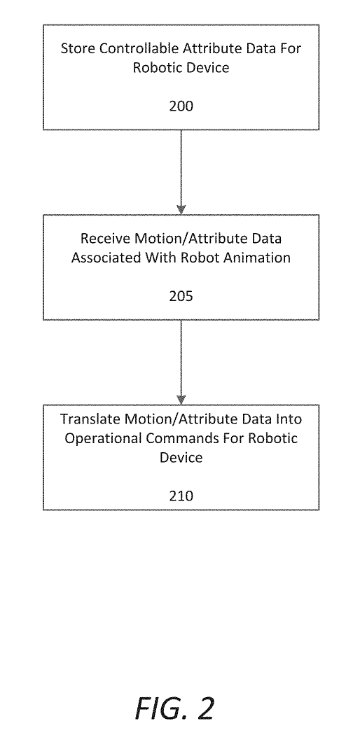

FIG. 2 is a high level flow chart describing an example method of modularizing motion and attribute data into operational commands. In the below description of FIG. 2, reference may be made to like reference characters representing various features of FIG. 1 for illustrative purposes. Furthermore, the high level method described in connection with FIG. 2 may be performed by an example data exchange system 100 as illustrated in FIG. 1. Referring to FIG. 2, the data exchange system 100 can store controllable attribute data for a robotic device (200). The controllable attribute data can comprise data indicating each of the various capabilities of the robotic device, such as the robotic device's motion and maneuvering capabilities (e.g., the ability of the robotic device to perform various emotional or reactive expressions). The controllable attribute data may also describe various features of the robotic device, such as the robotic device's lighting features, display features, audio capabilities, haptic systems, and the like.

The data exchange system 100 may receive motion and attribute data 161 corresponding to a virtual animation of a virtual character (205). As discussed above, the virtual animation can correspond to user interactions using intuitive animation tools of an animation application running on a computing device. Using the controllable attribute data for the robotic device, the data exchange system 100 can translate the motion and attribute data 161 into operational commands 142 to be implemented by a control system of the robotic device (210).

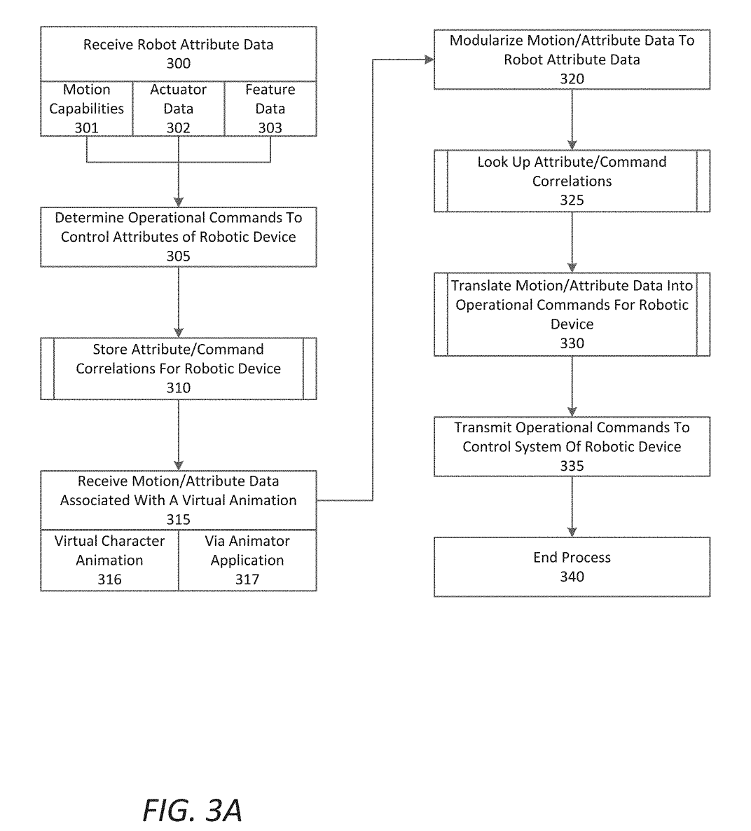

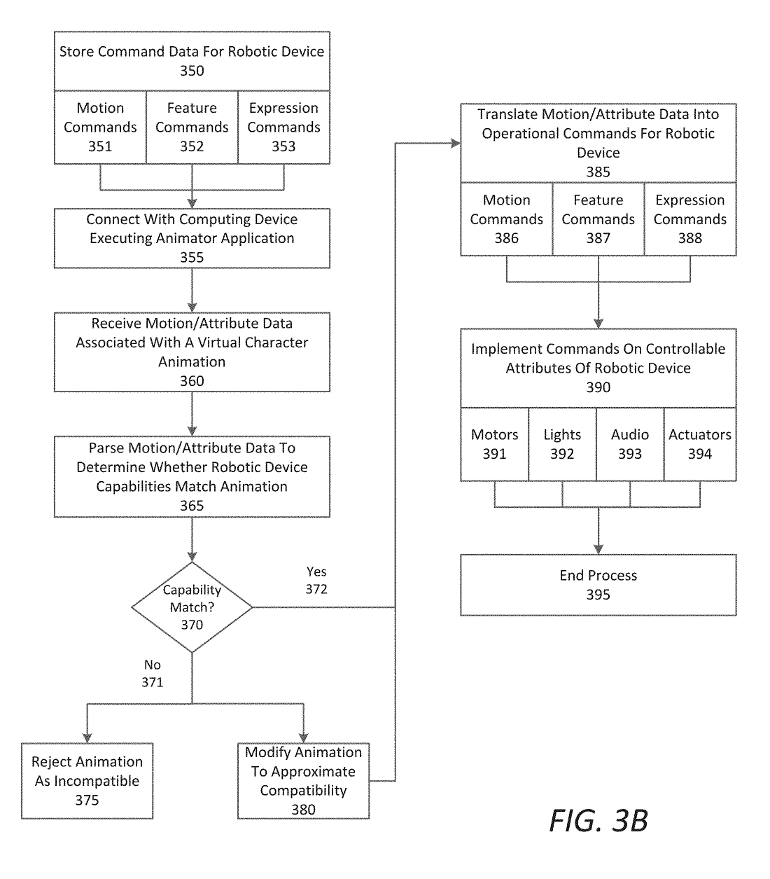

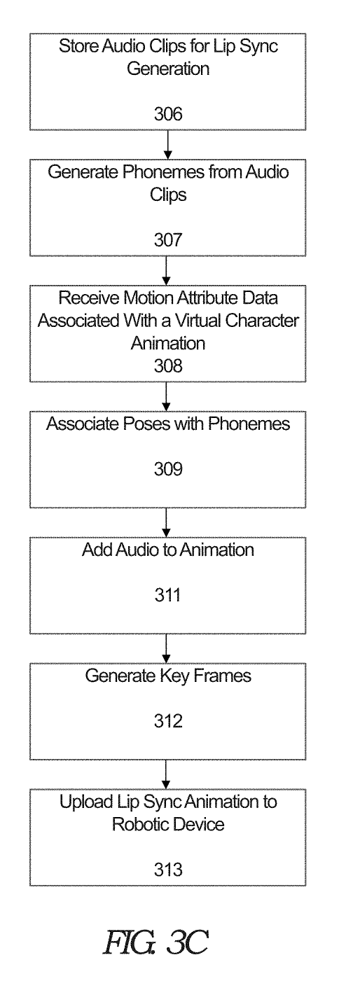

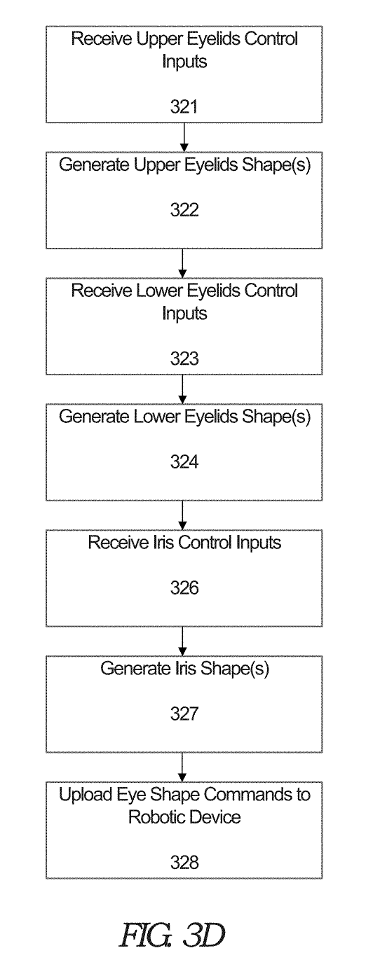

FIG. 3A is a low level flow chart describing an example method for modularizing motion and attribute data into operational commands in an external implementation. In the below description of FIGS. 3A and 3B, reference may be made to like reference characters representing various features of FIG. 1 for illustrative purposes. Furthermore, the low level methods described in connection with FIGS. 3A and 3B below, may be performed by an example data exchange system 100 as illustrated in FIG. 1. Referring to FIG. 3A, the data exchange system 100 can receive robot attribute data from any number of robotic devices (300). As discussed above, the robot attribute data for a particular robotic device, can describe each of the controllable aspects of the device, such as actuators (302) controlling robot joints, the robotic device's motion capabilities (301), motors controlling the robotic device's velocity and direction, display or light elements, sound elements, haptic elements, (collectively “feature data” (303)), and the like.

In some examples, the data exchange system 100 can determine the operational commands required to control the attributes of the robotic device (305). Such operational commands may correspond to commands transmitted to the robotic device using a remote controller. Accordingly, the data exchange system 100 can correlate the controllable attributes to the operational commands, and store the attribute and command correlations in a local memory (310).

The data exchange system 100 may receive motion and attribute data associated with a virtual animation of a virtual character on a computing device (315). As discussed above, the motion and attribute data may be associated with user interactions using intuitive animation tools of an animation application (317), and can include a single animation, or a series of animations comprising multiple triggered actions by the virtual character (316).

The data exchange system 100 can then modularize the motion and attribute data for use by a control system of a robotic device, and translate or format the modularized data into a set of operational commands based on the stored attribute data for the robotic device (320). Thus, the data exchange system 100 can look up the stored attribute and command correlations for a specified robotic device (325), and translate the motion and attribute data into operational commands that can be implemented by the robotic device in accordance with the animation(s) create by the user via the animation application (330). Once the operational commands are translated and formatting for implementation, the data exchange system 100 can transmit the operational commands to robotic device (335), and thereafter the process ends (340).

FIG. 3B is a low level flow chart describing an example method for modularizing motion and attribute data into operational commands in an internal implementation. That is, FIG. 3B describes an example data exchange module that may be provided as a part of the control system of the robotic device. The data exchange module can store attribute data for the robotic device (350), where the attribute data can consist of motion commands (351) to control movements and maneuvering of the robotic device, features commands (352) to control each of any number of features of the robotic device, and expression commands (353), which can enable the robotic device to perform predetermined expressions or movements. The data exchange system 100 may connect with a computing device which hosts the animation application (355) to receive motion and attribute data associated with a virtual character animation or series of animations and triggered responses (360). In some examples, the data exchange system 100 can parse the motion and attribute data (365) to determine whether the robotic device capabilities match the animation(s) (370). If not (371), the data exchange system 100 may reject the animation as incompatible (375) or modify the animation(s) to approximate compatibility (380). This can involve identifying certain portions of the motion and attribute data which are incompatible with the functions of the robotic device and either modifying those portions for compatibility, or ignoring those portions altogether.

If the robotic device is determined to be capable of performing the animation(s) (372), the data exchange system can modularize/translate the motion and attribute data to generate a series of operational commands for the robotic device (385). These operational commands can include motion commands (386) to cause the robotic device to move in a manner in accordance with the animation(s). The operational commands can further include feature commands (387), which can enable various features of the robotic device (e.g., the display or light elements, haptic elements, audio elements, etc.). As a part of the control system of the robotic device, the data exchange system 100 can further implement the operational commands on the various controllable attributes of the robotic device (390). For example, the data exchange system 100 can implement the commands on the motors (391) and actuators (394) to initiate movement of the robotic device. The data exchange system 100 can further implement operational commands on the display or light elements (392) and audio elements (393) of the robotic device. Once the robotic device is reconfigured in accordance with the animation application, the process ends (395).

In many implementations, the operational commands can configure the robotic device to perform certain triggered responses, such as anthropomorphic behavioral responses to certain actions. These actions can include, for example, physical interactions with the robotic device, the robotic device being placed on an inductive charge port, and various other actions utilizing any number of features of the robotic device (e.g., touch sensors, light sensors, microphones, accelerometers, gyroscopic sensors, magnetometers, etc.). Any number of such triggered responses may be configured by the user utilizing the animation tools of the animation application. Correspondingly, the operational commands can reflect those triggered responses by reprogramming or otherwise reconfiguring the robotic device to perform those configured reactions in response to the actions. Thus, the user of the animation application can configured the virtual character to react to actions, such as changes in light, sound, temperature, etc., making contact with an object, being held a certain way, establishing a connection, receiving power, etc.—each of which can be reflected in the reactions performed by the robotic device.

Furthermore, current software configurations of robotic devices (e.g., out-of-box device capabilities) may not exploit the full potential of the various controllable attributes of the robotic devices. The data exchange system 100 provided herein can enable such robotic devices to perform actions that cannot be performed using conventional programmable techniques or via remote operation. Specifically, the data exchange system 100 can enable visual designers and/or animators to evoke intent and provide finer granularity in a robotic device's expressions and movements.

Facial features may also be configured for the robotic device. For example, the facial features may include configurations of a mouth of the robotic device of lip sync capabilities and configurations of one or more eyes of the robotic device. The mouth and eyes of the robotic device may be displayed on a display, such as LCD screen. In some examples, the facial features, such as the eyes and the mouth, may also include mechanical or other physical components.

FIG. 3C depicts a flow chart of an example method for configuring a lip synchronization feature in a robotic device. The lip sync feature allows users to link robot poses to specific phoneme sounds and then automatically key those poses when phonemes are detected in audio clips laying on an animation timeline. To configure such a feature, audio clips are first stored at operation 306. For instance, the audio clips that are to be used for lip sync may be stored within a specified directory. At operation 307, the audio clips are accessed, and a plurality of phonemes are generated from the audio clips. In some examples, a program utilizing a speech recognition engine may be run to create a file that holds a reference to each audio clip, the phonemes detected within it, and the start and end frames of each phoneme. By doing so, less software, such as the speech recognition engine, needs to be installed on each user's workstation. Further, processing time is saved within the animation application. The animation application, or a plugin within the animation application, may then load the file and create a lookup table for referencing detected phonemes by the names of the stored audio clips.

At operation 308, the animation application receives motion attribute data associated with a virtual character animation. Operation 308 may be substantially similar to operation 360 described above. As an example, operation 308 allows for a user to create robot poses and connect them with specified phonemes. Poses may be created by selecting a robot control within the animation application, moving it to specific position, and then saving all the attributes for the control to be called back later. In some examples, the animation may relate to moving the mouth or a display of a mouth on the robotic device. In such an example, the user may move a mouth control with the animation application to the open position, create a pose, and then move the mouth control to closed and create another pose. The created poses are then saved or otherwise stored. At operation 309, once poses or other motion attribute data are created or received, a pose or motion attribute data and all phonemes desired to be associated with the pose may be selected. In some examples, the user selects a pose in a user interface of the animation application and selects all phonemes that the user want wants to associate with the pose. The associations are saved or otherwise stored. In some examples, the associations may be saved to a lookup table that the animation application may later use.

At operation, 311, audio is added to the animation. For example, the animation application, or a plugin, references the audio directory to display a set of audio clips for a user to select. The user may then select an audio clip to add it to the animation timeline. In some examples, to expedite the time needed to import audio clips into the animation application, as well as simplify timeline manipulation of multiple audio clips, the animation application or plugin creates a temporary audio clip and stitches together the data from selected audio clips saving it to the single file. The temporary audio clip is then added to the animations timeline. The audio clips that were selected and the time that for which they are keyed to play, may then be saved to a scene file. The use of the temporary audio file may be used for audio playback within the animation application and may not be used within the robotic device.

Key frames for the animation may then be generated at operation 312. For example, the animation application may present a lip sync user interface to select functionality to generated key frames. In such an example, the user may select a “Generate key frames” option within the lip sync user interface. The animation application or the plugin then may utilize both the lookup table which holds phonemes and frame data and the lookup table which holds poses and their associated phonemes to generate the key frames. As an example, for each audio clip used to generate the temporary audio file, the plugin iterates through each of the detected phonemes, and checks the pose lookup table to see if there is a pose associated with it. If a match is found, the time of that phonemes detection is calculated from: the start time of the audio clip, start frame that the phoneme is detected within the audio file, the animation application's animation playback rate settings. The plugin may then move a timeline scrubber to the calculated time on the timeline and create a key frame from the saved pose associated with that phoneme. When all key frames have been generated, the animation may be played back. Playing back the animation shows that each pose is executed at the time its associated phonemes would be detected in the audio clips. At operation 313, the lip sync animation is uploaded to the robotic device. For example, the keyed poses of the key frames may be used when uploading an animation to the robotic device to generate robot commands which execute the same poses represented within the animation application. In some examples, operation 313 may include similar functionality and steps as operations 320, 325, 330, 335, and 340, as discussed above.

FIG. 3D depicts a flow chart of an example method for configuring an eye control feature in a robotic device having an eye display. The animation application or plugin to the animation application may contain a series of eye controls that may be used to create robot commands which drive the shapes drawn on a display, such as an LCD screen, of the robotic device. In some examples, there are three eye commands that may be used for the eye control features: an upper eyelid shapes command, a lower eyelid shapes command, and a position the irises on the screen command. For each of these commands there is a set of controls to drive each.

More specifically, at operation 321 upper eyelids control inputs are received. The robotic device upper eyelids command takes parameters used to generate a curve that lies on the segment of a circle. To generate the parameters from the upper eyelid controls the control set consists of a plurality of controls for each eyelid. In some examples, there may be at least five controls. The controls may be moved along a x-axis and y-axis and lay in the same two-dimensional space as the LCD screen, which in some examples may have a resolution of about 320×120. Each eyelids control may lie in a specific order with first control (e.g., control #1) laying on the far left and last control (e.g., control #5) laying on the far right with the other controls lying in order between the first and last control. At operation 322, the upper eyelids shape(s) are generated from the controls. In an examples, as the controls are moved by a user of the animation application or the plugin, the animation application or the plugin attempts to calculate a circle or oval (or a portion thereof) with all the upper eyelids controls lying along its circumference. If the circle or oval (or the portion thereof) is able to be calculated, the animation application or plugin draws the circle or oval (or the portion thereof) under the controls and has the same dimensions as the calculated circle or oval (or the portion thereof). The circle or oval (or the portion thereof) informs the user that the controls are in a valid position. The animation application or plugin may then receive additional inputs to create the animation. For instance, the user may key the controls along the animation timeline in order to create a full animation. Upper eyelid commands may then be uploaded to the robotic device at operation 328.

In a particular example, for a three-dimensional representation, a segmented rectangle may be used to represent the upper eyelid shapes within a three-dimensional representation of the robotic device within the animation application. Skeletal joints may be positioned within the rectangle and the rectangle skinned to the skeletal joints so that the skeletal joints control the vertices of each rectangle segment in order to form the upper eyelid shape. Controls may be built within the animation application to drive the position of the skeletal joints. Each control may lay within a three-dimensional coordinate system in which the origin of the space represents the origin of the robotic device display's coordinate system. When the animation is ready to be uploaded, the animation application or the plugin steps through each key frame and collects the center point of each control which is used to calculate the circle or oval (or a portion thereof), its radius, and the angle along the circle to the first control and the last control. The circle or oval (or a portion thereof) data collected is then used to generate the upper eyelid robot commands and uploaded to the robot at operation 328.

Turning to the lower eyelids, lower eyelids control inputs are received at operation 323. The lower eyelids may be represented with ovals on the display of the robotic device. In some examples, the robot command to control them takes an x and y radius used to calculate the oval as well as the center point of the oval. There are a plurality of controls for each lower eyelid used to generate the robot commands. In some examples, there may be four controls for each lower eyelid. The user may position each of the controls within the animation application.

At operation 324, shapes for the lower eyelids are generated. A first half of the controls may sit at the same y-coordinate, and when the first half of the control are moved, the animation application or the plugin uses their distance apart to calculate an x-radius of the oval. The second half of the controls share the same x-coordinate, and the plugin or animation application uses their distance to calculate a y-radius of the oval. The center point of the oval is calculated by finding the center point of the plurality of controls. In some examples, a circle may also be rendered below the controls with its x-scale set by the calculated x-radius for the oval and its y-scale set by the calculated y-radius for the oval. In such an example, the circle helps the user visualize where the oval will be drawn on the display of the robotic device. The plurality of controls may then be keyed along the timeline in the same fashion as the upper eyelids and are exported or uploaded to the robotic device in a similar manner in operation 328.

In a particular example for three-dimensional representation, the eyelids are represented by creating a segmented plane and shaping it to a circle. The circle lays in the same three-dimensional space as the upper eyelid representation. The plane is then scaled in the same manner as the circle with its x-scale representing the x-radius of the oval and y-scale representing the y-radius of the oval.

Turning to the irises, the iris control inputs are received at operation 326. The robotic device command to position the irises takes an x-position control and y-position control for each iris. In some examples, the two controls move together since their distance apart will always be the same to create a more realistic eye animation. The shapes of the irises are then generated at operation 327. In some examples, the controls are represented by two circles that lay in the same two-dimensional space as the other eye controls (e.g., the controls for the upper eyelid and the controls for the lower eyelid). The position of each circle is then used to generate the robot command for export or upload to the robotic device in operation 328.

In a particular example for three-dimensional representation, the irises are represented by two cylinders and lays in the same three-dimensional space as the other eyelid representations. The position of the cylinders are driven by the iris controls. The iris controls may be keyed along the timeline in the same fashion as the other controls and exported in the same or similar manner as well.

In some examples, the commands for the upper eyelids, lower eyelids, and irises may all be combined and uploaded to the robotic device as a package in operation 328. Operation 328 may also include similar functionality and steps as operations 320, 325, 330, 335, and 340, as discussed above.

Example Robotic Devices

FIG. 4 is schematic diagram illustrating an example robotic device upon which examples described herein may be implemented. However, variations of the present disclosure are not limited to such devices. Rather, the above-discussed system 100 of FIG. 1 can be implemented with respect to any remote device in which pairings or connections are made. Referring to FIG. 4, the robotic device 400 can be of a size and weight allowing it to be easily grasped, lifted, and carried in an adult human hand. The robotic device 400 can include a spherical housing 402 with an outer surface that makes contact with an external surface of a corresponding magnetically coupled accessory device as the robotic device 400 rolls. In addition, the spherical housing 402 includes an inner surface 404. Additionally, the robotic device 400 includes several mechanical and electronic components enclosed by the spherical housing 402. In an example, robotic device 400 includes magnetic elements 482 which are supported within spherical housing 402 and which magnetically interact with complementary magnetic elements of a suitable accessory device. The magnetic interaction and coupling can occur and/or be maintained while the robotic device 400 moves.

The spherical housing 402 can be composed of a material that transmits signals used for wireless communication, yet is impervious to moisture and dirt. The spherical housing 402 can comprise a material that is durable, washable, and/or shatter-resistant. The spherical housing 402 may also be structured to enable transmission of light and can be textured to diffuse the light.

In one variation, the housing 402 is made of sealed polycarbonate plastic. In one example, the spherical housing 402 comprises two hemispherical shells with an associated attachment mechanism, such that the spherical housing 402 can be opened to allow access to the internal electronic and mechanical components.

Several electronic and mechanical components are located inside the envelope for enabling processing, wireless communication, propulsion and other functions (collectively referred to as the “interior mechanism”). In an example, the components include a drive system 401 to enable the device to propel itself. The drive system 401 can be coupled to processing resources and other control mechanisms, as described with other examples. The carrier 414 serves as the attachment point and support for components of the drive system 401. The components of the drive system 401 are not rigidly attached to the spherical housing 402. Instead, the drive system 401 can include a pair of wheels 418, 420 that are in frictional contact with the inner surface 404 of the spherical housing 402.

The carrier 414 is in mechanical and electrical contact with an energy storage 416. The energy storage 416 provides a reservoir of energy to power the device 400 and electronics and can be replenished through an inductive charge port 426. The energy storage 416, in one example, is a rechargeable battery. In one variation, the battery is composed of lithium-polymer cells. In other variations, other rechargeable battery chemistries are used.

The carrier 414 can provide the mounting location for most of the internal components, including printed circuit boards for electronic assemblies, sensor arrays, antennas, and connectors, as well as providing a mechanical attachment point for internal components.

The drive system 401 can include motors 422, 424 and wheels 418, 420. The motors 422 and 424 connect to the wheels 418 and 420, respectively, each through an associated shaft, axle, and gear drive (not shown). The perimeter of wheels 418 and 420 are two locations where the interior mechanism is in mechanical contact with the inner surface 404. The locations where the wheels 418 and 420 contact the inner surface 404 are an essential part of the drive mechanism of the robotic device 400, and so are preferably coated or covered with a material to increase friction and reduce slippage. For example, the wheels 418 and 420 can be covered with silicone rubber tires.

In some variations, a biasing mechanism 415 is provided to actively force the wheels 418, 420 against the inner surface 404. In an example illustrated by FIG. 4, the biasing mechanism 415 can comprise two or more separate portal axles 458, 460 to actively force the drive system wheels 418, 420 against the inner surface 404. The portal axles 458, 460 may include biasing elements 454, 456 (or springs) which include tips 455 or ends that press against the inner surface 404 with a force vector having a vertical value. The vertical force from the bias springs 454, 456 pressing against the inner surface 404 actively forces the drive system 401 and its respective wheels 418, 420 against the inner surface 404, thereby providing sufficient force for the drive system 401 to cause the robotic device 400 to move.

The portal axles 458, 460 comprising the independent biasing elements 454, 456 can be mounted directly onto the carrier 414. The biasing elements 454, 456 coupled to the portal axles 458, 460 may be in the form of torsion springs which instigate a force against the inner surface 404. As an addition or alternative, the biasing elements 454, 456 may be comprised of one or more of a compression spring, a clock spring, or a tension spring. Alternatively, the portal axles 458, 460 can be mounted, without inclusion of springs, to maintain a force pressing the drive system 401 and wheels 418, 420 against the inner surface 404, and allow sufficient traction to cause the robotic device 400 to move.

According to many examples, the robotic device 400 can include an inductive charge port 426 to enable inductive charging of a power source 426 used to provide power to the independent motors 422, 424 that power the wheels 418, 420. The robotic device 400 can further include a magnet holder 480 coupled to the carrier 414. The magnet holder 480 can include a set of magnetically interactive elements 482, such as elements comprised of ferrous materials, and/or electromagnets or permanent magnets. Likewise, an external accessory can also include complementary magnets for enabling the magnetic coupling. Thus, the magnet holder 480 and the external accessory can comprise one or more of any combination of magnetically interactive metals, ferromagnetic elements, neodymium, yttrium/cobalt, alnico, or other permanent elemental magnets, other “rare-earth” magnets, electromagnets, etc.

In variations, the magnet holder 480 can include a set of magnetic elements 482 (e.g., a magnet pair) which can be oriented to have opposing polarity. For example, as shown with other examples, the magnetic elements 482 include a first magnet and a second magnet, where the first magnet can be oriented such that its north magnetic pole faces upwards and its south magnetic pole faces downwards. The second magnet can be oriented such that its south magnetic pole faces upwards and its north magnetic pole face downwards.

In variations, the magnet holder 480 and an external accessory can each house any number or combination of complementary magnets or magnetic components. For example, a single magnetic component may be housed in either the robotic device 400 or in a corresponding external accessory, and be arranged to magnetically interact with a plurality of magnetic components of the other of the external accessory or the robotic device 400. Alternatively, for larger variations, magnetic arrays of three or more magnets may be housed within the spherical housing 402 to magnetically interact with a corresponding magnetic array of the external accessory.

In certain implementations, the magnet holder 480 may be incorporated on a pivot structure 473 driven by a pivot actuator 472. Thus, a control system (e.g., mounted to the carrier 414) of the robotic device 400 can operate the pivot actuator 472 to pivot the pivot structure 473 and thus the magnetic elements 482. The inductive charge port 426, each of the independent motors 422, 424, the pivot actuator 472, display or light elements (not shown), audio elements (not shown), haptic elements (not shown), etc. of the robotic device 400 can comprise the controllable attributes for purposes of operating the robotic device 400 by way of a data exchange system. As provided herein, a user operating an animation application and configuring a virtual representation of the robotic device on a computing device, can create animations, triggered responses, and the like for the virtual robotic device. The data exchange system can receive motion and attribute data correspond to those virtual animations, and convert, translate, format and/or modularize the motion and attribute data into operational control for implementation on the robotic device 400.

In some examples, the biasing mechanism 415 is arranged such that the wheels 418, 420 and the tip ends 455 of the biasing elements 454, 456 are almost constantly engaged with the inner surface 404 of the spherical housing 402. As such, much of the power from the motors 422, 424 is transferred directly to rotating the spherical housing 402, as opposed to causing the internal components (i.e., the biasing mechanism 415 and internal drive system 401) to pitch. Thus, while motion of the robotic device 400 may be caused, at least partially, by pitching the internal components (and therefore the center of mass), motion may also be directly caused by active force of the wheels 418, 420 against the inner surface 404 of the spherical housing 402 (via the biasing mechanism 415) and direct transfer of electrical power from the motors 422, 424 to the wheels 418, 420. As such, the pitch of the biasing mechanism 415 may be substantially reduced, and remain substantially constant (e.g., substantially perpendicular to the external surface on which the robotic device 400 moves). Additionally or as an alternative, the pitch of the biasing mechanism 415 may increase (e.g., to over 45 degrees) during periods of hard acceleration or deceleration. Furthermore, under normal operating conditions, the pitch of the biasing mechanism 415 can remain stable or subtly vary (e.g., within 10-15 degrees).

In some variations, the magnetic elements 482 can be replaced or augmented with magnetic material, which can be included on, for example, the tip ends 455 of the biasing elements 454, 456. The tip ends 455 can be formed of a magnetic material, such as a ferrous metal. Such metals can include iron, nickel, cobalt, gadolinium, neodymium, samarium, or metal alloys containing proportions of these metals. Alternatively, the tip ends 455 can include a substantially frictionless contact portion, in contact with the inner surface 404 of the spherical housing 402, and a magnetically interactive portion, comprised of the above-referenced metals or metal alloys, in contact or non-contact with the inner surface 404. As another variation, the substantially frictionless contact portion can be comprised of an organic polymer such as a thermoplastic or thermosetting polymer.

In some examples, the tip ends 455 can be formed of magnets, such as polished neodymium permanent magnets. In such variations, the tip ends 455 can produce a magnetic field extending beyond the outer surface of the spherical housing 402 to magnetically couple with the external accessory device. Alternatively still, the tip ends 455 can include a substantially frictionless contact portion, and have a magnet included therein.

Alternatively still, one or more magnetic components of the robotic device 400 may be included on any internal component, such as the carrier 414, or an additional component coupled to the biasing mechanism 415 or the carrier 414.

In further examples, one or more of the magnetic elements 482, the tip ends 455, and/or the complementary magnets of the external accessory device can comprise any number of electro- or permanent magnets. Such magnets may be irregular in shape to provide added magnetic stability upon motion of the self-propelled device 400. For example, the magnetic elements 482 of the self-propelled device 400 can be a single or multiple magnetic strips including one or more tributary strips to couple with the complementary magnet(s) of the accessory device. Additionally, or alternatively, the tip ends 455 can also include a single or multiple magnets of different shapes which couple to complementary magnets of the accessory device.

Alternatively, the magnetic coupling between the self-propelled device 400 and the accessory device can be one which creates a stable magnetically repulsive state. For example, the magnetic elements 482 can include a superconductor material to substantially eliminate dynamic instability of a repelling magnetic force in order to allow for stable magnetic levitation of the accessory device in relation to the magnetic elements 482 while the spherical housing 402 rotates on the underlying surface. In similar variations, a diamagnetic material may be included in one or more of the self-propelled device 400, the tip ends 455, or the external accessory device, to provide stability for magnetic levitation. Thus, without the use of guiderails or a magnetic track, the self-propelled device 400 may be caused to maneuver in any direction with the external accessory device remaining in a substantially constant position along a vertical axis of the self-propelled device 400 (Cartesian or cylindrical z-axis, or spherical r-coordinate with no polar angle (θ)).

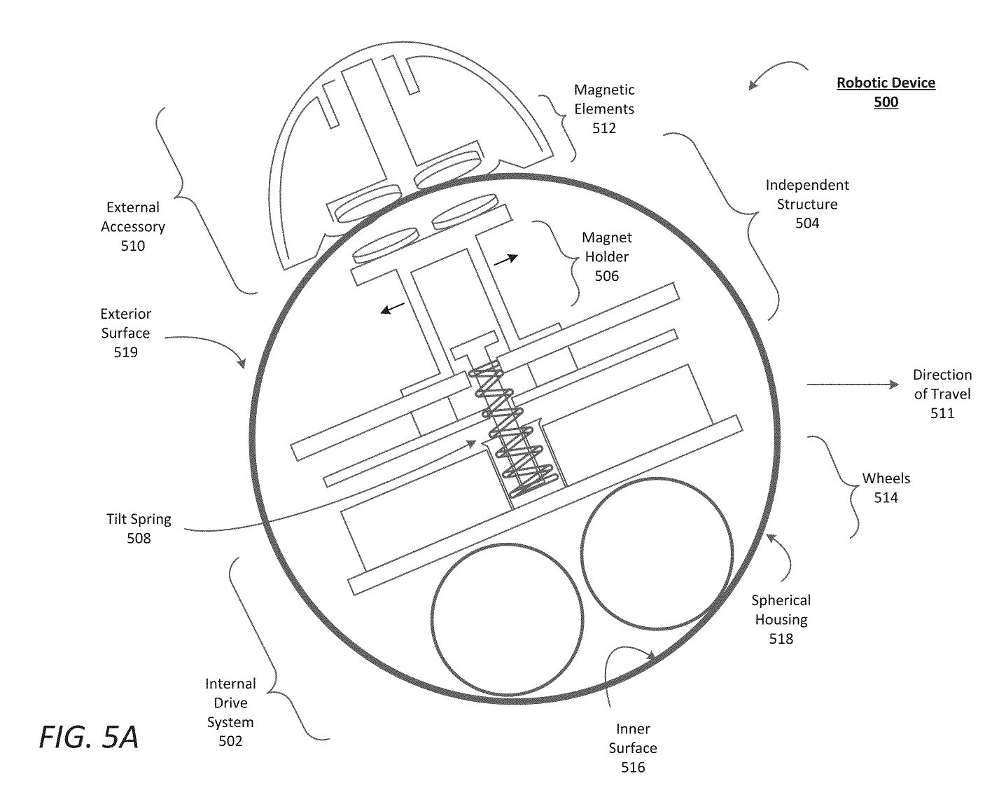

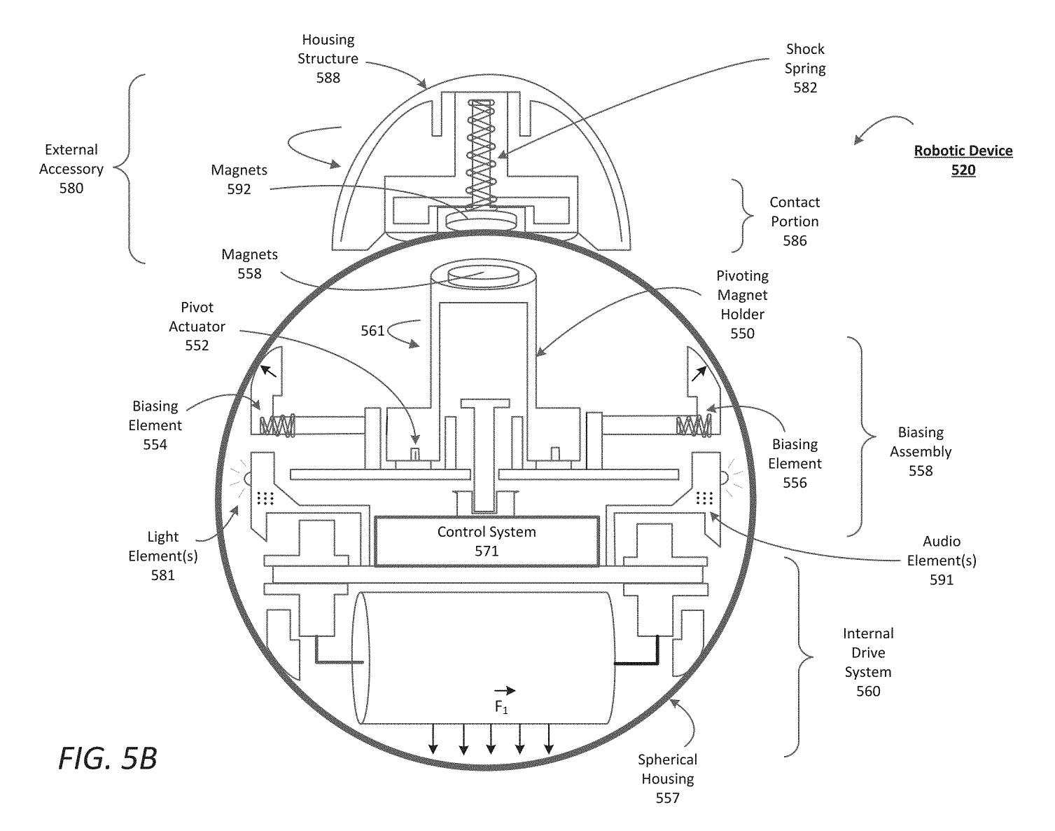

FIG. 5A is a cross-sectional side view of an example self-propelled device including an independent internal structure and a structure for magnetic coupling to an external accessory device. In the below description of FIG. 5A, the self-propelled device 500 may incorporate numerous features of other examples provided herein. Referring to FIG. 5A, the self-propelled device 500 can include an internal drive system 502 to cause the self-propelled device 500 to move in any one of multiple possible directions. The internal drive system 502 can be biased, by one or more biasing elements, in order to cause a number of wheels 514 to continuously engage the inner surface 516 of the spherical housing 518. Thus, as the self-propelled device 500 is remotely operated by a controller device, the internal drive system 502 causes the spherical housing 518 to roll and maneuver in accordance with received control commands.

As shown, the internal drive system 502 can cause the internal components of the robotic device 500 to pitch, thereby displacing the center of mass forward and causing the spherical housing 518 to roll. In the example provided in FIG. 5A, the robotic device 500 is moving in the direction of travel 511 indicated.

According to examples described herein, the robotic device 500 can include an external accessory, where magnetic elements and the robotic device 500 can magnetically interact through the spherical housing 518 with corresponding magnetic elements or material of the external accessory, such that as the spherical housing 518 rolls, the magnetic interaction between the magnetic elements 512 and the corresponding magnetic elements or material of the external accessory causes the magnet holder 506 upon which the magnetic elements of the robotic device 500 are housed to maintain a positional relationship with the external accessory. Thus, the spherical housing 518 may roll and maneuver based on received control commands, and the magnetic elements 512 may maintain continuous interaction with the magnetic elements or material of the external accessory device.

In some examples, the magnet holder 506 can be directly coupled to the internal drive system 502, or a carrier on which components such as a circuit board are integrated. Alternatively, the magnet holder 506 can be coupled to an independent internal structure 507 that is coupled to the internal drive system via a tilt spring 508. As shown in FIG. 5A, the tilt spring 508 can allow for an amount of shock absorption when the robotic device 500 experiences a collision event. The tilt spring 508 can further dampen an impact force experienced by the independent internal structure 507, in order to lessen jolts, jerk events, and/or jounces experienced by the robotic device 500. Such events may increase the probability that the magnetic elements will decouple, causing the external accessory coupled to the robotic device 500 to detach. The tilt spring 508 can decrease the probability of such decoupling events.

FIG. 5B is a cross-sectional front view of an example robotic device including a biasing assembly and a structure for magnetic coupling to an accessory device. The robotic device 520 may be a variant of the robotic device 500 as described with respect to FIG. 5A. As an example, the independent internal structure 507 of FIG. 5A may be included as part of a biasing assembly 558 as shown in FIG. 5B. Furthermore, while not shown in FIG. 5B, the robotic device 520 may also include a tilt spring 508 as provided in FIG. 5A. Referring to FIG. 5B, the internal drive system 560 of the robotic device 520 can be biased by the biasing assembly 558. The biasing assembly can include a number of biasing elements 554, 556, which can include springs, or other devices storing mechanical energy, in order to produce a continuous force on the inner surface of the spherical housing 557. The force provided by the biasing elements 554, 556 can cause the internal drive system 560 to exert a continuous force (F₁) on the inner surface of the spherical housing 557 so that when power is provided to wheels within device 520, the turning wheels cause the robotic device 520 to roll and maneuver.

Any number of biasing elements 554, 556 may be included within the spherical housing 557. Such biasing elements 554, 556 may be included on the biasing assembly 558, and also as part of the internal drive system 560 to provide stability and decrease the pitch and/or roll of the internal components of the robotic device 520 during operation. A reduction in the tilting of the internal components of robotic device 520 can cause the external accessory to maintain contact with the spherical housing 557 within a tighter positional area on a top portion of the robotic device 520 as the robotic device 520 moves.

According to examples, the biasing assembly 558 can include a pivoting magnet holder 550, which can pivot a number of degrees (e.g., 10-20), or which can be set on a guide system to pivot a full 360 degrees. The pivoting magnet holder 550 can include a pair of magnets 562 oriented with opposing polarity to each other. Complementary magnets of a corresponding external accessory can also be oriented with opposing polarity to each other, such that the external accessory can only be attached to the robotic device 520 and the opposing magnets on the external accessory couple to the opposing magnets 562 on the pivoting magnet holder 550. Accordingly, as the pivoting magnet holder 550 pivots, the external accessory pivots accordingly.

The biasing assembly 558 can further include a pivot actuator 552 which, based on a control command received from a controller device, can cause the pivoting magnet holder 550 to turn. In an example where the device of FIG. 5B is implemented with the system 100 of FIG. 1, a pivot command can be received via a transducer 102 and processed by a processor 114 (as shown in FIG. 1) in order to implement the command on the pivot actuator 552. Thus, a control feature on the controller device, such as a user interface feature on a virtual steering mechanism, can be used to receive user input which causes the pivoting magnet holder 550 to turn, and thereby causes the external accessory to turn. The pivot actuator 552 can be controlled to turn clockwise or counterclockwise dynamically in response to such pivot commands.

Additionally or alternatively, the robotic device 520 may be preprogrammed to cause the pivot actuator 552 to activate in response to certain events. For example, upon starting up, the robotic device 520 may be preprogrammed to detect a direction towards the controller device. Based on the direction of the controller, the internal drive system 560 can rotate the robotic device 520 in order calibrate a forward direction for the robotic device 520 in relation to the controller device. In addition, the pivot actuator 552 may be automatically enabled to turn the pivoting magnet holder 550 such that the external accessory faces the controller device.

Additionally or alternatively, the pivoting magnet holder 550 may have a default forward direction that coincides with a calibrated forward direction of the internal drive system 560. Thus, as the robotic device 520 is initially calibrated to the controls of the controller device, the pivot actuator 552 may be enabled to automatically calibrate a forward facing direction for the external accessory. Furthermore, the pivot actuator 552 may be automatically initiated during collision events or when another robotic device is detected within a predetermined distance. Further still, combinations of actions may be performed by the internal drive system 560 and the pivot actuator 552 to elicit anthropomorphic behavior by the robotic device 520.

As shown in FIG. 5B, the robotic device 520 can include a control system 571 connected to various controllable attributes of the robotic device 520. Such controllable attributes can include, without limitation, audio elements 591, display or light elements 581, haptic elements (not shown), the pivot actuator 552 used to pivot the magnets 558 and thus the external accessory 580, and the internal drive system 560 (which itself can include a number of independent motors). Using an animator application and an intuitive animator tool, a user (e.g., an artist, game developer, animator, etc.) can manipulate a virtual representation of the robotic device 520 on a computing device. The virtual robotic device can include the same or similar functions as those of the physical robotic device 520. The user can configure the virtual robotic device to perform movements, actions, and triggered responses using the animator tool on the computing device.

For example, the user can configure the virtual robotic device to respond to a collision event by lighting up, spinning around, and making a sound. As another example, the user can configure the virtual robotic device to respond to being placed on an inductive charger by emitting a tranquil light pattern indicative of a deep sleep mode. As yet another example, the user can configure the virtual robotic device to perform emotive actions in response to virtual user interactions with the virtual robotic device, such as anthropomorphic head shakes, nods, vibrations, turning the pivoting external accessory to face the user via a motion detection sensor, and the like. The extent to such configurations and triggers are virtually limitless, and therefore the data exchange between the animation application and the physical robotic device allows for physical configurations and trigger for the physical robotic device to be equally limitless.

As discussed extensively herein, these virtual movements, actions, and triggered responses may be transformed, or modularized for the robotic device 520 via the data exchange system. Thus, all such limitless virtual manipulations on the virtual robotic device by the user can be implemented as operational controls on the control system 571 of the robotic device 520.

According to examples, the external accessory can also include features to dampen shock events, such as when the robotic device 520 goes over bumps or experiences collisions. The external accessory can thus include a contact portion to maintain contact with the outer surface of the spherical housing 557, and a housing structure to support any number of functional or non-functional features. For example, such a housing structure can include one or more sensors (e.g., thermometer, smoke detector, etc.) to provide information to a user, such as a current temperature or barometric pressure. Alternatively, the housing structure can include one or more illuminating elements, such as light emitted diodes that can be functional (e.g., provide a warning or indication) or purely decorative. To further anthropomorphize the robotic device 520, one or more speakers may be included to provide audible sounds in response to certain events. Such sounds may be communicative in order to, for example, provide information, elicit emotional responses, or indicate detection of a certain event, such as detecting another robotic device or mobile computing device. Accordingly, the internal drive system 560, the pivot actuator 552, functional or non-functional components of the external accessory, and/or one or more speakers can be combined to enable the robotic device 520 engage in anthropomorphic behavior.

The contact portion of the external accessory can be coupled to the housing structure by one or more shock springs to reduce the effect of impacts on the magnetic coupling. In an aspect of FIG. 5A, as the robotic device 520 goes over bumps or experiences collision events, the tilt spring 508 as well as a shock spring of the external accessory can dampen such events to decrease the likelihood of the external accessory decoupling with the robotic device 520.

Hardware Diagram

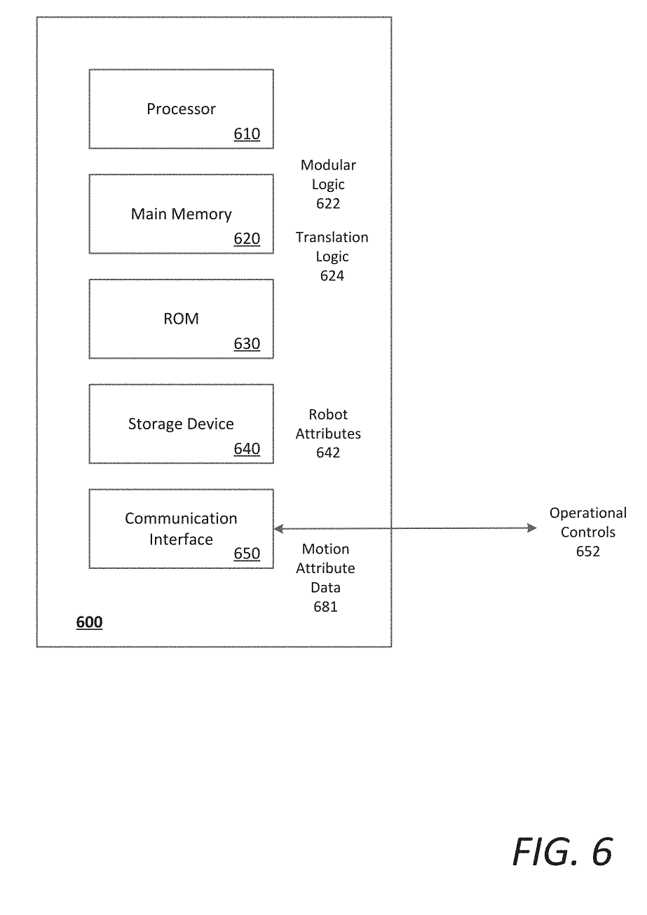

FIG. 6 is a block diagram that illustrates a computer system upon which examples described may be implemented. For example, one or more components discussed with respect to the data exchange system 100 of FIG. 1, and the methods described herein, may be performed by the system 600 of FIG. 6. The systems and methods described can also be implemented using a combination of multiple computer systems as described by FIG. 6.

In one implementation, the computer system 600 includes processing resources 610, a main memory 620, ROM 630, a storage device 640, and a communication interface 650. The computer system 600 includes at least one processor 610 for processing information and a main memory 620, such as a random access memory (RAM) or other dynamic storage device, for storing information and instructions to be executed by the processor 610. The main memory 620 also may be used for storing temporary variables or other intermediate information during execution of instructions to be executed by the processor 610. The computer system 600 may also include a read only memory (ROM) 630 or other static storage device for storing static information and instructions for the processor 610. A storage device 640, such as a magnetic disk or optical disk, is provided for storing information and instructions. For example, the storage device 640 can correspond to a computer-readable medium that store instructions performing negotiation and correlation operations discussed with respect to FIGS. 1-5B.

The communication interface 650 can enable computer system 600 to communicate with a robotic device and/or a computing device utilizing an animation application (e.g., cellular or Wi-Fi network) through use of a network link (wireless or wired). Using the network link, the computer system 600 can communicate with a plurality of devices, such as the robotic device and the computing device operating the animation application. The main memory 620 of the computer system 600 can further store the modularization logic 622 and translation logic 624, which can be initiated by the processor 610. Furthermore, the computer system 600 can receive motion and attribute data 681 from the computing device operating the animation application. The processor 610 can execute the modularization and/or translation logic 622, 624 to utilize the robot attributes of the robotic device and generate operational controls 652 based on the motion and attribute data 681 for a virtual character.

The computer system 600 can further transmit the operational commands 652 to the robotic device. Such commands 652 may be implemented by a control system of the robotic device to perform the various movements, actions, and triggered responses configured by the user on the virtual character using the animation application.

Examples described herein are related to the use of computer system 600 for implementing the techniques described herein. According to one example, those techniques are performed by computer system 600 in response to processor 610 executing one or more sequences of one or more instructions contained in main memory 620, such as the control application 645, negotiation logic 612, or correlation logic 614. Such instructions may be read into main memory 620 from another machine-readable medium, such as storage device 640. Execution of the sequences of instructions contained in main memory 620 causes processor 610 to perform the process steps described herein. In alternative implementations, hard-wired circuitry and/or hardware may be used in place of or in combination with software instructions to implement examples described herein. Thus, the examples described are not limited to any specific combination of hardware circuitry and software.

Conclusion

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that this disclosure is not limited to those precise examples. As such, many modifications and variations will be apparent to practitioners skilled in this art. Accordingly, it is intended that the scope of this disclosure be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

While certain examples have been described above, it will be understood that the examples described are by way of example only. Accordingly, this disclosure should not be limited based on the described examples. Rather, the scope of the disclosure should only be limited in light of the claims that follow when taken in conjunction with the above description and accompanying drawings.

What is claimed is:

1. A system comprising:
one or more processors; and
one or more memory resources storing instructions that, when executed by the one or more processors, cause the system to:
receive motion and attribute data corresponding to facial features of a robotic device via a robot animation application, the motion and attribute data associated with a virtual animation of at least a portion of the robotic device; and
translate the motion and attribute data for implementation on a robotic device to perform the virtual animation in a real-world environment.

2. The system of claim 1, wherein the executed instructions further cause the system to:
store data associated with a number of controllable attributes of the robotic device; and
wherein translating the motion and attribute data comprises utilizing the data associated with the controllable attributes to transform the motion and attribute data into operational controls for execution on the controllable attributes of the robotic device.

3. The system of claim 2, wherein the controllable attributes comprise features of a display of the robotic device.

4. The system of claim 1, wherein the facial features include a mouth of the robotic device and at least one eye of the robotic device.

5. The system of claim 1, wherein the motion and attribute data corresponds to a number of anthropomorphic facial expressions of a virtual character in the virtual animation, and wherein the executed instructions cause the system to implement the operational controls on the robotic device to invoke the anthropomorphic expressions in the real-world environment.

6. The system of claim 2, wherein the controllable attributes further comprise at least one of a set of audio devices, a set of display or light elements, and a set of motors to drive a drive system of the robotic device.

7. The system of claim 1, wherein the executed instructions further cause the system to:
store audio clips for lip sync generation;
generate phonemes from the stored audio clips; and
associate poses of at least a portion of the robotic device with the phonemes;
generate key frames based on the phonemes and the associated poses; and
wherein the motion and attribute data includes the key frames.

8. The system of claim 1, wherein the executed instructions further cause the system to:
receive control inputs for an upper eyelid of the robotic device;
generate at least one shape for the upper eyelid based on the control inputs for the upper eyelid;
receive control inputs for a lower eyelid of the robotic device;
generate at least one shape for the upper eyelid based on the control inputs for the lower eyelid;
receive control inputs for an iris of the robotic device; and
generate at least one shape for the iris based on the control inputs for the iris.

9. The system of claim 8, wherein the at least one shape for the upper eyelid includes a circle, the at least one shape for the lower eyelid includes an oval, and the at least one shape for the iris includes a circle.

10. A computer-implemented method for configuring lip synchronization functionality in a robotic device, the method comprising:
accessing one or more audio clips to be associated with the lip synchronization functionality;
generating a plurality of phonemes from the one or more audio clips;
receiving motion attribute data associated with a virtual character animation;
associating the motion attribute data with the plurality of phonemes;
adding at least one of the one or more audio clips to an animation timeline; and
generating key frames for the animation based on the associated motion attribute data and the audio clips.

11. The computer implemented method of claim 10, wherein the motion attribute data includes poses of at least a portion of the robotic device.

12. The computer-implemented method of claim 10, further comprising:
creating a lookup table for at least one of the plurality of phonemes; and
wherein associating the motion attribute data with the plurality of phonemes further comprises saving the associations in the lookup table.

13. The computer-implemented method of claim 12, wherein generating key frames further comprises utilizing the lookup table.

14. The computer-implemented method of claim 10, wherein generating key frames further comprises:
generating a temporary audio file for an audio clip in the one or more audio clips;
iterating through detected phonemes in the audio file;
identifying a lookup table associated with a detected phoneme for a particular iteration; and
calculating a time of the phoneme detection based on at least one of a start time of the audio clip, a start frame that the phoneme is detected within the audio file, or a playback rate setting of an animation application.

15. A computer-implemented method for configuring an eye control feature in a robotic device having an eye display, the method comprising:
receiving a plurality of control inputs for upper eyelids of eyes on the eye display;
generating a shape and a command for the upper eyelids based on the upper eyelids control inputs;
receiving a plurality of control inputs for lower eyelids of the eyes on the eye display;
generating a shape and a command for the lower eyelids based on the lower eyelids control inputs;
receiving a plurality of control inputs for irises of the eyes on the eye display;
generating a shape and a command for the irises based on the irises control inputs; and
uploading the command for the upper eyelids, the command for the lower eyelids, and the command for the irises to the robotic device.

16. The computer-implemented method of claim 15, wherein:
the shape generated for the upper eyelids is a circle, wherein the upper eyelids control inputs lie on a circumference of the circle; and
the shape generated for the lower eyelids is an oval, wherein the lower eyelids control inputs lie on a circumference of the oval.

17. The computer-implemented method of claim 16, wherein the upper eyelids control inputs include at least five control inputs and the lower eyelids control inputs include at least four control inputs.

18. The computer-implemented method of claim 15, wherein:
generating a shape and a command for the lower eyelids based on the lower eyelids control inputs comprises calculating an x center location, y center location, a radius, and start and end curve angles on a plurality of upper eyelid controls; and
generating a shape and a command for the lower eyelids based on the lower eyelids control inputs comprises calculating an x location, y location, horizontal radius, and vertical radius on a plurality of lower eyelid controls.

19. The computer-implemented method of claim 15, further comprising generating a three-dimensional representation of:
the upper eyelids based on the upper eyelids control inputs;
the lower eyelids based on the lower eyelids control inputs; and
the irises based on the irises control inputs.

20. The computer-implemented method of claim 15, wherein the irises control inputs include:
a single input for a first iris indicating an x-axis value and a y-axis value for the first iris; and
and a single input for a second iris indicating an x-axis value and a y-axis value for the second iris.
